(19) United States
(12) Patent Application Publication
(10) Pub. No.: US 2016/0033154 A1
(43) Pub. Date: Feb. 4, 2016

(54) COMMUNICATION RELAY DEVICE, COMMUNICATION RELAY METHOD, AND PROGRAM

(71) Applicant: MITSUBISHI ELECTRIC CORPORATION, Tokyo (JP)

(72) Inventors: Tomoaki GYOTA, Tokyo (JP); Masanori NAKATA, Tokyo (JP); Hiroko KOBORI, Tokyo (JP)

(21) Appl. No.: 14/775,878

(22) PCT Filed: Apr. 17, 2013
(86) PCT No.: PCT/JP2013/061415

§ 371 Date: Sep. 14, 2015

(51) Int. Cl. F24F 11/00; G05B 15/02

(52) U.S. Cl. CPC F24F 11/006; F24F 11/001; F24F 11/0086; G05B 15/02; F24F 2011/0052; F24F 2011/0061; F24F 2011/0068; F24F 2011/0093

(57) ABSTRACT

A communication relay device comprises a processor, a reception unit, and a transmission unit. The communication relay device is connected to air conditioning units via a network. The air conditioning units comprise sensors and send unit signals containing output values of the sensors to a control device controlling the air conditioning units via the communication relay device. The reception unit receives the unit signals. The processor converts the unit signals received by the reception unit to unit signals containing values used for testing the operation of the control device and different from the output values of the sensors. Then, the transmission unit sends the unit signals converted by the processor to the control device.

### TECHNICAL FIELD

The present disclosure relates to a communication relay device, communication relay method, and program.

### BACKGROUND ART

Buildings or commercial facilities are often provided with air conditioning units conditioning the indoor air and a control device controlling the air conditioning units. Such air conditioning units detect, for example, the indoor air condition and send signals presenting the detection results to the control device. Then, the control device controls the air conditioning units based on the signals received from the air conditioning units.

When a control device is installed, some tests are conducted to ensure that the control device operates properly upon reception of various signals. Then, in such tests, techniques of making the air conditioning units send various signals are used (for example, see Patent Literature 1).

The communication relay device described in Patent Literature 1 relays communication between an air conditioning unit and a monitoring device monitoring the air conditioning unit. The communication relay device orders the air conditioning unit to output an abnormal signal. Then, a test can be conducted to determine whether proper notification is given to the monitoring device of an abnormal event occurring to the air conditioning unit.

### CITATION LIST

### Patent Literature

Patent Literature 1: Unexamined Japanese Patent Application Kokai Publication No. 2011-122741.

### SUMMARY OF INVENTION

### Technical Problem

However, the technique described in the Patent Literature 1 requires the air conditioning unit to have the capability of interpreting an order from the communication relay device and outputting an abnormal signal. Therefore, when a control device is connected to an existing air conditioning unit that does not have such a capability, it may be difficult to conduct the test

The present disclosure is made with the view of the above situation and an objective of the disclosure is to easily conduct the test when a control device is installed.

### SOLUTION TO PROBLEM

In order to achieve the above objective, the communication relay device of the present disclosure comprises:

reception means for receiving signals sent from air conditioning units provided with sensors and containing output values of the sensors;

conversion means for converting the signals received by the reception means to signals containing values that are used for testing an operation of a control device for controlling the air conditioning units and that are different from the output values; and

transmission means for transmitting the signals converted by the conversion means to the control device.

### ADVANTAGEOUS EFFECTS OF INVENTION

With the present disclosure, the test when a control device is installed can easily be conducted.

### BRIEF DESCRIPTION OF DRAWINGS

FIG. 1 is a block diagram showing the configuration of the air conditioning system according to Embodiment 1;

FIG. 2 is a block diagram showing the configuration of the communication relay device;

FIG. 3 is an illustration showing exemplary packets saved in the buffer;

FIG. 4 is an illustration showing an example of the conversion table;

FIG. 5 is an illustration showing an exemplary screen displayed by the user interface;

FIG. 6 is a flowchart showing a series of processing executed by the communication relay device;

FIG. 7 is a flowchart showing the screen update procedure;

FIG. 8 is a diagram showing the configuration of the air conditioning equipment according to Embodiment 2;

FIG. 9 is a block diagram showing the configuration of the communication relay device;

FIG. 10 is an illustration showing an example of the conversion table;

FIG. 11 is a flowchart showing a series of processing executed by the communication relay device;

FIG. 12 is a flowchart showing the unit ID list creation procedure; and

FIG. 13 is an illustration showing an example of the unit ID list.

### DESCRIPTION OF EMBODIMENTS

Embodiments of the present disclosure will be described hereafter with reference to the drawings.

### Embodiment 1

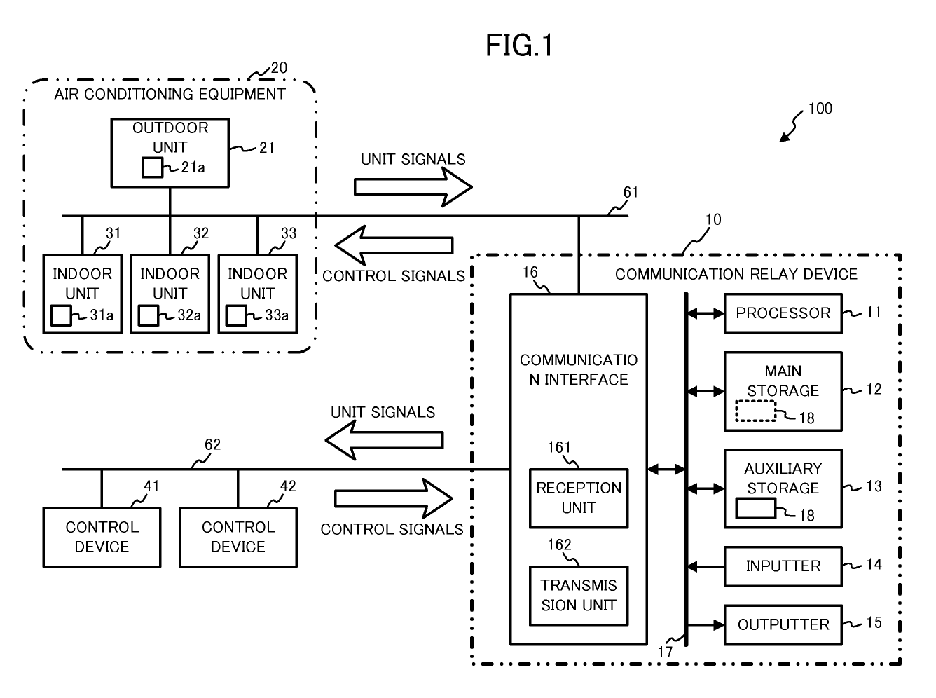

FIG. 1 shows the configuration of an air conditioning system 100 according to this embodiment. The air conditioning system 100 is a system adjusting the air condition (the temperature and the like) in an air-conditioning target space using air conditioning units. The air conditioning system 100 has a communication relay device 10, air conditioning equipment 20, and control devices 41 and 42.

The air conditioning equipment 20 includes an outdoor unit 21 and indoor units 31, 32, and 33 as air conditioning units. These air conditioning units are all connected to the communication relay device 10 via a first network (communication line) 61. The first network 61 is, for example, a wired LAN (local area network).

The outdoor unit 21 circulates a refrigerant to/from the indoor units 31 to 33 using a compressor, a thermal expansion valve, and the like for heat exchange between the refrigerant and the outdoor air. On the other hand, the indoor units 31 to 33 are each installed on the ceiling or a wall of an air-conditioning target room. Receiving control signals via the first network 61, the indoor units 31 to 33, for example, suck the air according to the control signals and discharge the air of a given temperature from the vent.

The outdoor unit 21 and indoor units 31 to 33 have sensors 21a, 31a, 32a, and 33a, respectively, as shown in FIG. 1. The sensors 21a and 31a to 33a detect the states of the air conditioning units constituting the air conditioning equipment 20 and the air condition in the air-conditioning target space. For example, the sensor 21 a is a pressure sensor detecting the pressure of the compressor. On the other hand, the sensors 31a to 33a are temperature sensors detecting the temperature of the air sucked by the indoor units 31 to 33. The air conditioning units send unit signals containing output values of the sensors 21a and 31a to 33a to the control devices 41 and 42 via the communication relay device 10.

The control devices 41 and 42 are remote control terminals for someone in the air-conditioning target room to set a desired temperature and the like. The control devices 41 and 42 are both connected to the communication relay device 10 via a second network 62. The second network 62 is, for example, a wireless LAN.

The control devices 41 and 42 receive unit signals sent from the air conditioning units of the air conditioning equipment 20 via the communication relay device 10. Furthermore, the control devices 41 and 42 send control signals containing commands to the air conditioning units based on the unit signals to control the air conditioning units.

The communication relay device 10 relays communication between the air conditioning units and the control devices 41 and 42. The communication relay device 10 has, as shown in FIG. 1, a processor 11, a main storage 12, an auxiliary storage 13, an inputter 14, an outputter 15, and a communication interface 16. The main storage 12, auxiliary storage 13, inputter 14, outputter 15, and communication interface 16 are all connected to the processor 11 via an internal bus 17.

The processor 11 comprises, for example, a CPU (central processing unit) or the like. The processor 11 executes programs 18 stored in the auxiliary storage 13 to execute the procedures described later. The main storage 12 comprises, for example, a RAM (random access memory) or the like. The main storage 12 loads the programs 18 from the auxiliary storage 13. Then, the main storage 12 is used as the work area of the processor 11.

The auxiliary storage 13 is configured to include a nonvolatile memory such as a flash memory. The auxiliary storage 13 stores various data used in the processing of the processor 11 in addition to the programs 18. Then, the auxiliary storage 13 supplies the processor 11 with data the processor 11 uses and stores data supplied from the processor 11 according to instructions of the processor 11.

The inputter 14 comprises input keys, a pointing device, and the like for the user of the communication relay device 10 to enter information. The inputter 14 acquires and informs the processor 11 of the entered information. On the other hand, the outputter 15 comprises an LCD (liquid crystal display), a speaker, and the like for presenting information to the user. The outputter 15 displays to the user given characters and graphics according to instructions of the processor 11. The inputter 14 and outputter 15 according to this embodiment are integrally formed to constitute a touch screen.

The communication interface 16 has a reception unit 161 and a transmission unit 162 for packet communication via the first network 61 and second network 62. The reception unit 161 notifies the processor 11 of information acquired via the first network 61 and second network 62. On the other hand, the transmission unit 162 outputs information notified from the processor 11 to the first network 61 and second network 62.

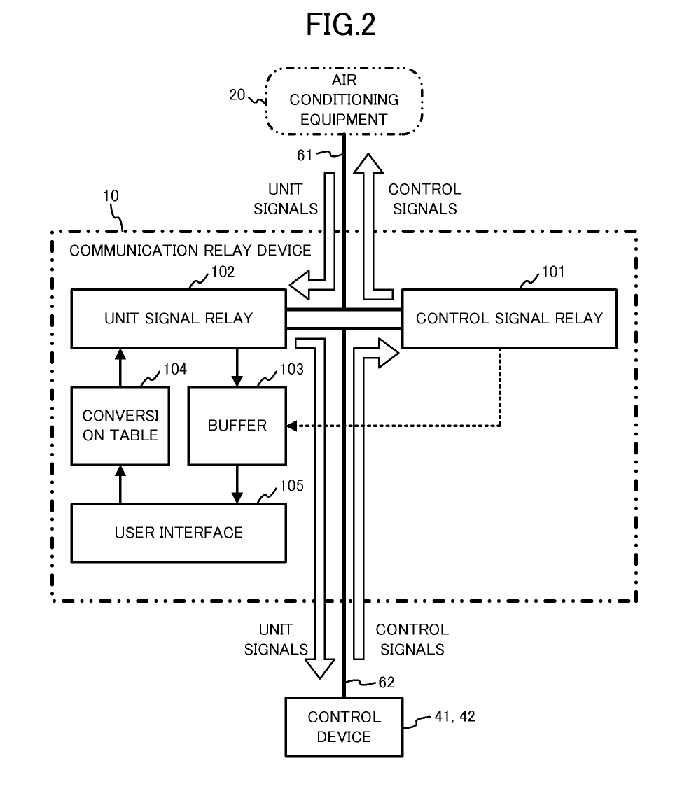

FIG. 2 shows the functional configuration of the communication relay device 10. As shown in FIG. 2, the communication relay device 10 has a control signal relay 101, a unit signal relay 102, a buffer 103, a conversion table 104, and a user interface 105.

The control signal relay 101 is realized mainly by the processor 11 and communication interface 16. The control signal relay 101 receives packets carrying control signals from the control devices 41 and 42 via the second network 62. The control signal relay 101 duplicates and stores in the buffer 103 the packets. Then, the control signal relay 101 outputs the received packets to the first network 61 as they are so as to send the control signals to the air conditioning units.

The unit signal relay 102 is realized mainly by the processor 11 and communication interface 16. The unit signal relay 102 receives packets carrying unit signals from the air conditioning units via the first network 61. The unit signal relay 102 duplicates and stores in the buffer 103 the received packets. Furthermore, the unit signal relay 102 converts the received packets in part based on the conversion table 104. Then, the unit signal relay 102 outputs the converted packets to the second network 62 so as to send the unit signals to the control devices 41 and 42.

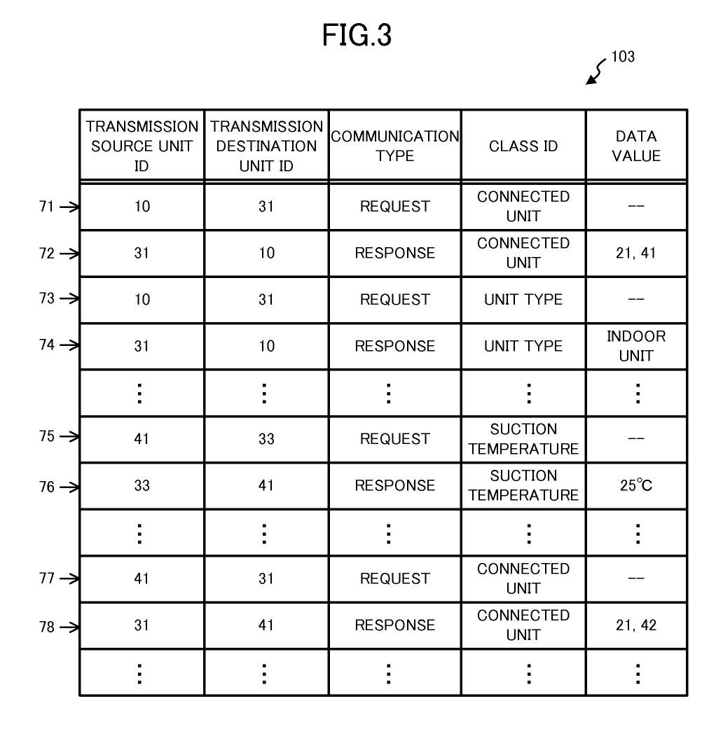

The buffer 103 is realized mainly by the main storage 12. FIG. 3 shows received packets 71 to 78 as exemplary packets saved in the buffer 103. As shown in FIG. 3, each packet contains a transmission source unit ID, a transmission destination unit ID, a communication type, a class ID, and a data value.

The unit ID is information for identifying the units constituting the air conditioning system 100. Since a packet contains a unit ID as an indicator of the transmission destination, the control signals and unit signals sent from the communication relay device 10 are received by a proper air conditioning unit or control devices 41 and 42. Here, the unit IDs according to this embodiment are equal to the reference numbers given to the units for the purpose of convenience. For example, the unit ID of the indoor unit 31 is “31.”

The communication type is information presenting either “REQUEST” indicating a packet for requesting notification of data or “RESPONSE” indicating a packet for responding to a request.

The class ID is information for identifying the class of the data notified with the packet. Furthermore, the data value presents a specific value of the data notified with the packet. For example, when the class ID is “CONNECTED UNIT,” the data value presents the unit ID of the unit linked to the air conditioning unit. Furthermore, when the class ID is “UNIT TYPE,” the data value presents the type of the air conditioning unit (indoor unit, outdoor unit, or the like). When the class ID is “SUCTION TEMPERATURE” or “COMPRESSOR PRESSURE,” the data value presents the output values of the sensors 21a and 31a to 33a of the air conditioning units.

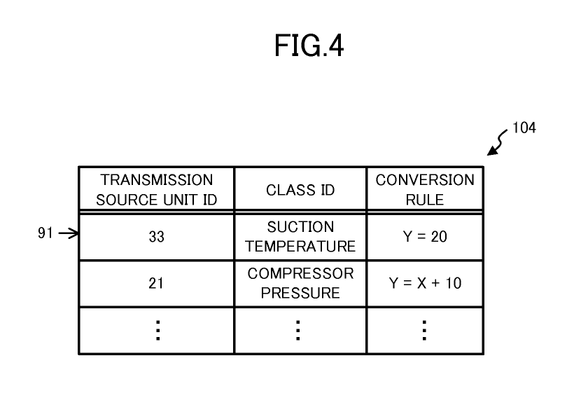

The conversion table 104 is data in the form of a table stored in the auxiliary storage 13. The conversion table 104 has, as shown in FIG. 4, multiple rows of data containing a transmission source unit ID, a class ID, and a conversion rule, which are associated with each other.

The conversion rule is a rule to rewrite the data value so as to convert the unit signals. The conversion rule is defined using X presenting the data value contained in the unconverted packet and Y presenting the data value contained in the converted packet so that the converted data value is used in the operation test of the control devices 41 and 42.

The user interface 105 is realized mainly by the processor 11, inputter 14, and outputter 15. The user interface 105 analyzes the packets saved in the buffer 103 to acquire information regarding the air conditioning unit. Furthermore, the user interface 105 displays a screen for the user to set a conversion rule based on the acquired information. Then, the user interface 105 updates the conversion table 104 according to the user input

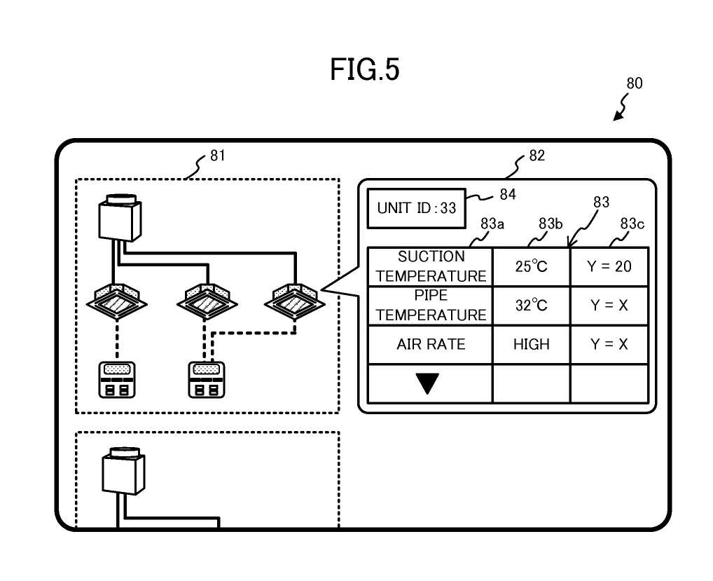

FIG. 5 shows a display screen 80 as an exemplary screen displayed by the user interface 105. The display screen 80 has a configuration area 81 and a setting area 82.

The configuration area 81 displays the configuration of the air conditioning system 100 including the communication relay device 10. The air conditioning units and control devices 41 and 42 are presented by icons in the configuration area 81. Furthermore, the links between the air conditioning units and other units are presented by lines connecting the icons. For example, in FIG. 5, the links indicating the refrigerant pipes physically connecting the outdoor unit 21 and indoor units 31 to 33 are presented by solid lines. On the other hand, the link indicating the subordinate relation between the indoor unit 31 and the control device 41 controlling the indoor unit 31 and the links indicating the subordinate relation between the indoor units 32 and 33 and the control device 42 controlling the indoor units 32 and 33 are presented by broken lines.

The setting area 82 presents information regarding the air conditioning unit selected by the user. The setting area 82 is displayed as the user touches an icon within the configuration area 81 with a finger to select an air conditioning unit. The setting area 82 contains, as shown in FIG. 5, a setting table 83 showing information regarding the selected air conditioning unit and a box 84 showing the unit ID of the selected air conditioning unit.

The setting table 83 is a table comprising multiple rows. Each row of the setting table 83 contains a received class ID 83a, a received data value 83b, and a setting box 83c.

The received class ID 83a presents the class ID contained in a packet saved in the buffer 103. The received data value 83b presents the data value contained in a packet saved in the buffer 103. For example, when the received packet 76 shown in FIG. 3 is saved in the buffer 103, the setting table 83 corresponding to the indoor unit 33 has a row containing the received class ID 83a of “SUCTION TEMPERATURE” and received data value 83b of “25° C.”

The setting box 83c is an input field for the user to set a conversion rule. Before the user enters a conversion rule, the setting box 83c displays a conversion rule associated with both the class ID equal to the received class ID 83a and the unit ID of the selected air conditioning unit in the conversion table 104. For example, when a row of data 91 shown in FIG. 4 is contained in the conversion table 104, the setting table 83 corresponding to the indoor unit 33 has a row containing the received class ID 83a of “SUCTION TEMPERATURE” and setting box 83c displaying “Y=20.”

The user can change the content of the setting box 83c by operating the physical input keys or a software keyboard displayed on the screen. For example, the user can change the conversion rule by entering “Y=X+10” in the setting box 83c in which the conversion rule “Y=20” is displayed.

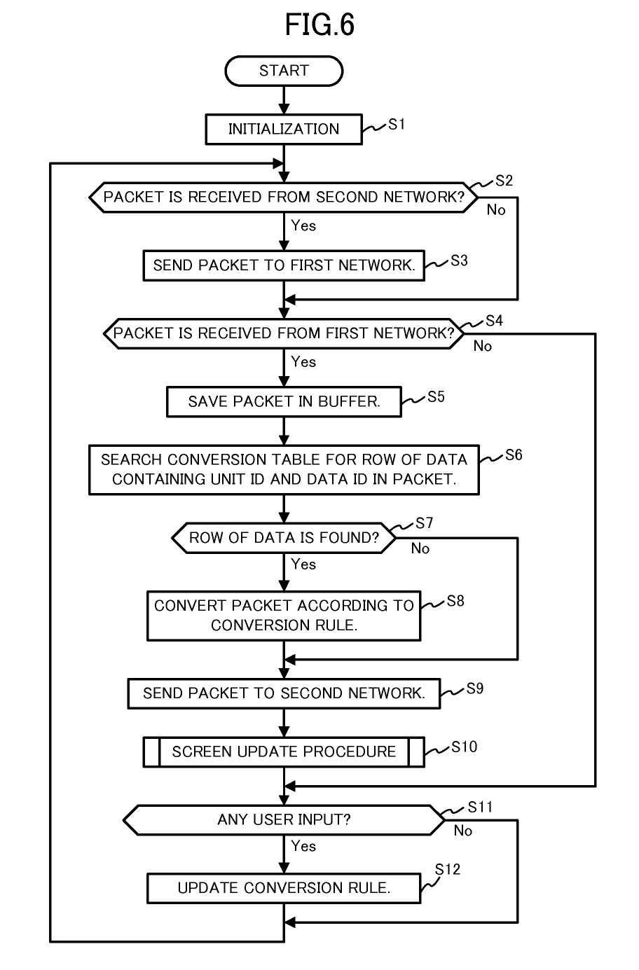

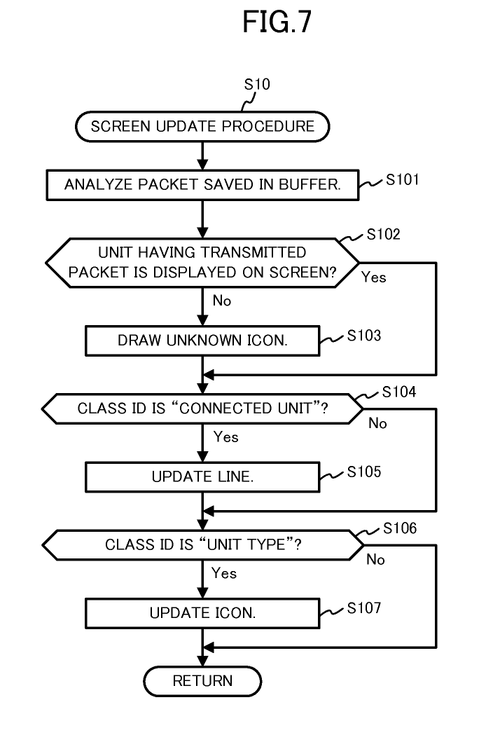

A series of processing executed by the communication relay device 10 will be described hereafter using FIGS. 6 and 7. The series of processing shown in FIG. 6 starts as the communication relay device 10 is powered on.

First, the processor 11 executes initialization (Step S1). More specifically, the processor 11 creates packets for requesting data presenting the “CONNECTED UNIT” and “UNIT TYPE” from all units connected to the communication relay device 10. The processor 11 duplicates and saves in the buffer 103 the created packets. Then, the processor 11 sends the created packets to the air conditioning units and control devices 41 and 42. The received packets 71 and 73 in FIG. 3 are the packets identical to the packets sent to the indoor unit 31 in this initialization.

As a result, the air conditioning units and control devices 41 and 42 send packets and notify the communication relay device 10 of data presenting the “CONNECTED UNIT” and “UNIT TYPE.” The processor 11 receives and saves in the buffer 103 the packets. The received packets 72 and 74 in FIG. 3 are the packets sent from the indoor unit 31 and saved in the buffer 103 in the initialization.

As this initialization is executed, the packets containing the class IDs “CONNECTED UNIT” and “UNIT TYPE” and a data value are accumulated in the buffer 103 for all units connected to the communication relay device 10. As a result, the configuration area 81 as shown in FIG. 5 is displayed on the screen of the user interface 105.

Then, the processor 11 functions as the control signal relay 101 to determine whether a packet is received from the second network 62 (Step S2). If no packet is received (Step S2; No), the processor 11 advances the processing to Step S4.

On the other hand, if a packet is received (Step S2; Yes), the processor 11 duplicates and saves in the buffer 103 the received packet and sends the received packet to the first network 61 as it is without changing the data value (Step S3). For example, the received packets 75 and 77 in FIG. 3 correspond to the packets saved in the buffer 103 in the Step S3.

Then, the processor 11 functions as the unit signal relay 102 to determine whether a packet is received from the first network 61 (Step S4). If no packet is received (Step S4; No), the processor 11 advances the processing to Step S11.

On the other hand, if a packet is received (Step S4; Yes), the processor 11 saves the received packet in the buffer 103 (Step S5). For example, the received packets 76 and 78 in FIG. 3 correspond to the packets saved in the buffer 103 in the Step S5.

Then, the processor 11 searches the conversion table 104 for a row of data containing the unit ID and class ID in the packet (Step S6). More specifically, the processor 11 extracts the transmission source unit ID and class ID from the packet received in the immediately preceding Step S4. Then, the processor 11 searches the conversion table 104 for a row of data containing both the extracted unit ID and class ID.

For example, when the received packet 76 in FIG. 3 is received, the processor 11 searches the conversion table 104 for a row of data containing both the unit ID “33” and class ID “SUCTION TEMPERATURE” contained in the received packet 76.

Then, the processor 11 determines whether a row of data is found as a result of the search (Step S7). If no row of data is found (Step S7; No), the processor 11 advances the processing to Step S9.

On the other hand, if a row of data is found (Step S7; Yes), the processor 11 converts the received packet according to the conversion rule contained in the row of data (Step S8). For example, when the received packet 76 in FIG. 3 is received, the processor 11 finds the row of data 91 in FIG. 4 as a result of the search. Then, the processor 11 rewrites the data value in the received packet 76 from “25° C.” to “20° C.” according to the conversion rule “Y=20” contained in the row of data 91.

Then, the processor 11 sends the packet to the second network 62 (Step S9). As a result, if the determination is negative in the Step S6, the packet is sent to the second network 62 without rewriting the data value therein. On the other hand, if the determination is affirmative in the Step S6, the packet in which the data value is rewritten is sent to the second network 62.

Then, the processor 11 functions as the user interface 105 to execute the screen update procedure (Step S10). In the screen update procedure, the screen displayed to the user is updated.

As shown in FIG. 7, in the screen update procedure, the processor 11 first analyzes the packet last saved in the buffer 103 (Step S101). For example, the processor 11 analyzes the received packet 78 in FIG. 3 and recognizes the indoor unit 31 being linked to the outdoor unit 21 and control device 42.

Then, the processor 11 determines whether the unit having transmitted the packet is displayed on the screen (Step S102). More specifically, the processor 11 determines whether the icon corresponding to the transmission source unit ID contained in the packet is displayed on the screen of the user interface 105. If the determination is affirmative in the Step S102 (Step S102; Yes), the processor 11 advances the processing to Step S104.

On the other hand, if the determination is negative in the Step S102 (Step S102; No), the processor 11 draws an unknown icon indicating that the unit type is unknown (Step S103). The unknown icon is, for example, a question mark or blank square.

Then, the processor 11 determines whether the class ID contained in the packet is the “CONNECTED UNIT” (Step S104). If the class ID is not the “CONNECTED UNIT” (Step S104; No), the processor 11 advances the processing to Step S106.

On the other hand, if the class ID is the “CONNECTED UNIT” (Step S104; Yes), the processor 11 updates the line indicating the link between the unit having transmitted the packet and another unit (Step S105). For example, when the received packet 78 in FIG. 3 is analyzed, the processor 11 deletes the line connecting the indoor unit 31 and control device 41 and adds a line connecting the indoor unit 31 and control device 42.

Then, the processor 11 determines whether the class ID in the packet is the “UNIT TYPE” (Step S106). If the class ID is the “UNIT TYPE” (Step S106; Yes), the processor 11 updates the icon corresponding to the unit having transmitted the packet to the icon suitable for the data value contained in the packet (Step S107).

Subsequently, the processor 11 ends the screen update procedure and returns to the series of processing shown in FIG. 6. Moreover, if the class ID is not the “UNIT TYPE” (Step S106; No), the processor 11 returns to the series of processing as well.

Returning to FIG. 6, following the screen update procedure (Step S10), the processor 11 determines whether there is any input from the user (Step S11). If there is no input (Step S11; No), the processor 11 repeats the processing of the Step S2 and subsequent steps.

On the other hand, if there is any input (Step S11; Yes), the processor 11 updates the conversion rule. More specifically, the processor 11 associates the unit ID of the air conditioning unit selected by the user, the received class ID 83a contained in the same row as the setting box 83c in which the user input is received, and the entered conversion rule and adds a new row of data to the conversion table 104. However, if a row of data containing the same combination of the unit ID and class ID preexists in the conversion table 104, the processor 11 overwrites the conversion rule in this row of data.

Subsequently, the processor 11 repeats the processing of the Step S2 and subsequent steps.

Here, the processing by the control signal relay 101 corresponds to the Steps S1 and S2. The processing by the unit signal relay 102 corresponds to the Steps S3 to S9. The processing by the user interface 105 corresponds to the Steps S10 to S12.

As described above, the communication relay device 10 according to this embodiment receives unit signals from conventional air conditioning units and rewrites the sensor output values and the like contained in the unit signals to convert the unit signals. Then, the communication relay device 10 sends the unit signals having the output values and the like rewritten to the control devices 41 and 42.

As a result, for example, the control devices 41 and 42 receive unit signals containing values different from the actual temperatures measured by the temperature sensors of the air conditioning units. Thus, the operation test when the control devices 41 and 42 are installed can easily be conducted using the existing air conditioning equipment 20 as it is.

For example, the communication relay device 10 can convert the value of the suction temperature to an abnormal one to conduct a test simulating failure of the temperature sensor. Furthermore, the communication relay device 10 can convert the value of the suction temperature to a higher one by a given quantity than the actual value to conduct a test simulating drifting of the temperature sensor due to deterioration with time.

Furthermore, since the packets actually sent from the air conditioning units are individually converted, there is no need of preparing packets the control devices 41 and 42 receive in the operation test. As a result, there is no need of preparing a large number of packets corresponding to various configurations of the air conditioning equipment 20 and then the capacities of the main storage 12 and auxiliary storage 13 can be reduced. Thus, the communication relay device 10 can be configured with inexpensive hardware.

Furthermore, after the operation test is done, the air conditioning system 100 can be operated with the communication relay device 10 removed from the configuration in the operation test. Therefore, during the operation test, all components of the air conditioning system 100 except for the communication relay device 10 can be operated under the same conditions as in the regular operation.

Furthermore, there is almost no time lag required for the communication relay device 10 to relay. Therefore, the timing of the control devices 41 and 42 to receive packets in the operation test is nearly the same as the timing of the control devices 41 and 42 to receive packets in the regular operation of the air conditioning system 100. As a result, the time-related conditions of the air conditioning system 100 in the operation test can be nearly the same as in the regular operation.

Furthermore, the user interface 105 displays to the user the configuration of the air conditioning system 100 and information regarding the air conditioning units. Then, the user interface 105 acquires the conversion rule entered by the user and updates the conversion table 104. As a result, the user can enter a conversion rule while acknowledging the configuration of the air conditioning system 100 and the states of the air conditioning units. Thus, erroneous operations such as selection of a wrong air conditioning unit or input of a conversion rule with a wrong class ID can be prevented.

Furthermore, the communication relay device 10 monitors the packets to relay after the initialization. As a result, the contents displayed on the screen are always maintained in the latest state. For example, when a new air conditioning unit is added to the air conditioning equipment 20 and when a new control device is connected to the second network 62, the contents displayed on the screen are maintained in the latest state.

### Embodiment 2

Embodiment 2 will be described hereafter mainly in regard to the difference from the above-described Embodiment 1. Here, the same or equivalent components are referred to by the equivalent reference numbers and their explanation will be omitted or simplified.

The communication relay device 10 according to this embodiment is different from the one according to Embodiment 1 in that the user interface 105 is omitted. Furthermore, the communication relay device 10 according to this embodiment is different from the one according to Embodiment 1 in adapting to various configurations of the air conditioning equipment 20 without any operation of the user.

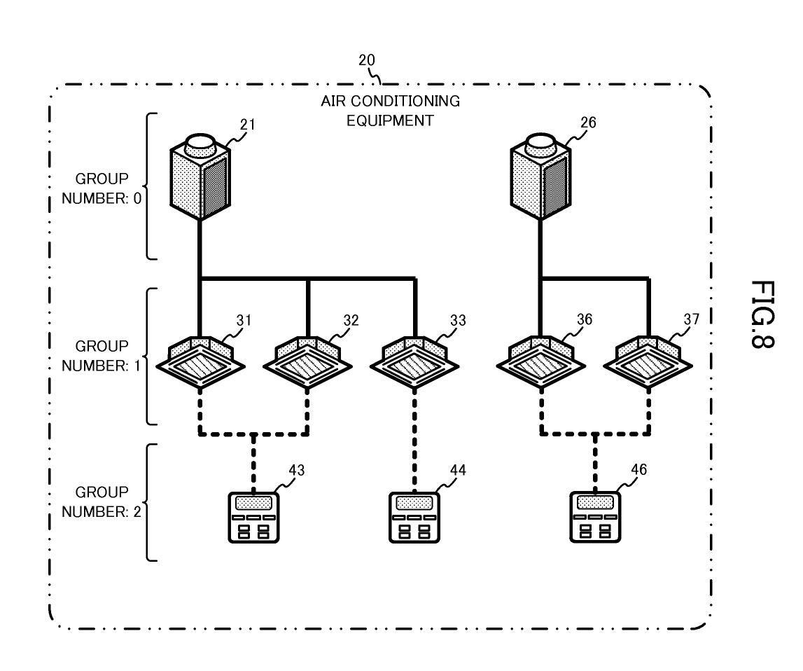

The air conditioning system 100 according to this embodiment has the same configuration as shown in FIG. 1. However, the air conditioning equipment 20 has, as shown in FIG. 8, outdoor units 21 and 26, indoor units 31, 32, 33, 36, and 37, and operation terminals 43, 44, and 46 as air conditioning units. The air conditioning units constituting the air conditioning equipment 20 are all connected to the first network 61.

The operation terminals 43, 44, and 46 are, for example, terminals for someone in the air-conditioning target room to adjust the air direction and air rate of the indoor units 31, 32, 33, 36, and 37.

In FIG. 8, the links between the air conditioning units of the air conditioning equipment 20 are presented by lines. For example, the link indicating the refrigerant pipe physically connecting the outdoor unit 21 and indoor units 31 to 33 and the link indicating the refrigerant pipe physically connecting the outdoor unit 26 and indoor units 36 and 37 are presented by solid lines. Furthermore, the link indicating the subordinate relation between the indoor units 31 and 32 and the operation terminal 43 for operating the indoor units 31 and 32, the link indicating the subordinate relation between the indoor unit 33 and the operation terminal 44 for operating the indoor unit 33, and the link indicating the subordinate relation between the indoor units 36 and 37 and the operation terminal 46 for operating the indoor units 36 and 37 are presented by broken lines.

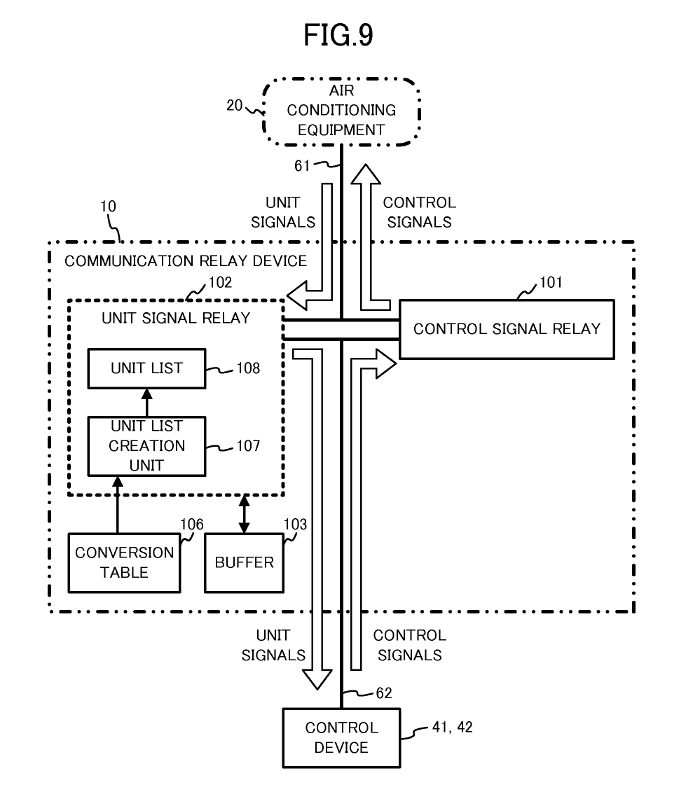

FIG. 9 shows the functional configuration of the communication relay device 10. As shown in FIG. 9, the communication relay device 10 has a conversion table 106 in place of the conversion table 104.

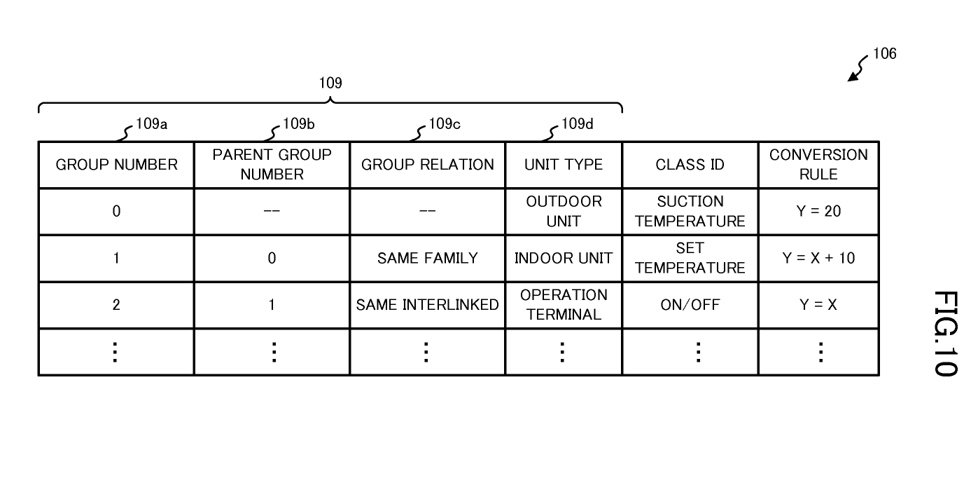

The conversion table 106 contains, as shown in FIG. 10, a group definition section 109. The group definition section 109 comprises a group number 109a, a parent group number 109b, a group relation 109c, and a unit type 109d. The group number 109a, parent group number 109b, group relation 109c, unit type 109d, class ID, and conversion rule are associated with each other.

The group number 109a is information for identifying the groups the air conditioning units belong to. The group having a group number 109a of zero is defined only with the unit type 109d. In the example shown in FIG. 10, the group comprising the outdoor units has a group number 109a of zero. On the other hand, the groups having any group number 109a but zero are defined with the parent group number 109b and group relation 109c in addition to the unit type 109d.

The parent group number 109b indicates the group that links to the group having a group number 109a as a parent group. The group relation 109c indicates the relation between the group having a group number 109a and the parent group thereof.

In the example shown in FIG. 10, the group having a group number 109a of 1 comprises the indoor units having “SAME FAMILY” relation to the air conditioning units belonging to the group having a group number 109a of zero. The “SAME FAMILY” relation means that the air conditioning units are connected by one and the same refrigerant pipe. On the other hand, the group having a group number 109a of 2 comprises the operation terminals having “SAME INTERLINKED” relation to the air conditioning units belonging to the group having a group number 109a of 1. The “SAME INTERLINKED” relation means that the air conditioning units operate in an interlinked manner with operation of the operation terminal.

Returning to FIG. 9, the unit signal relay 102 has a unit ID list creation unit 107 and a unit ID list 108.

The unit ID list creation unit 107 creates the unit ID list 108 based on packets received via the first network 61. Created for each group defined in the conversion table 106, the unit ID list 108 is a list of unit IDs presenting the air conditioning units belonging to the group.

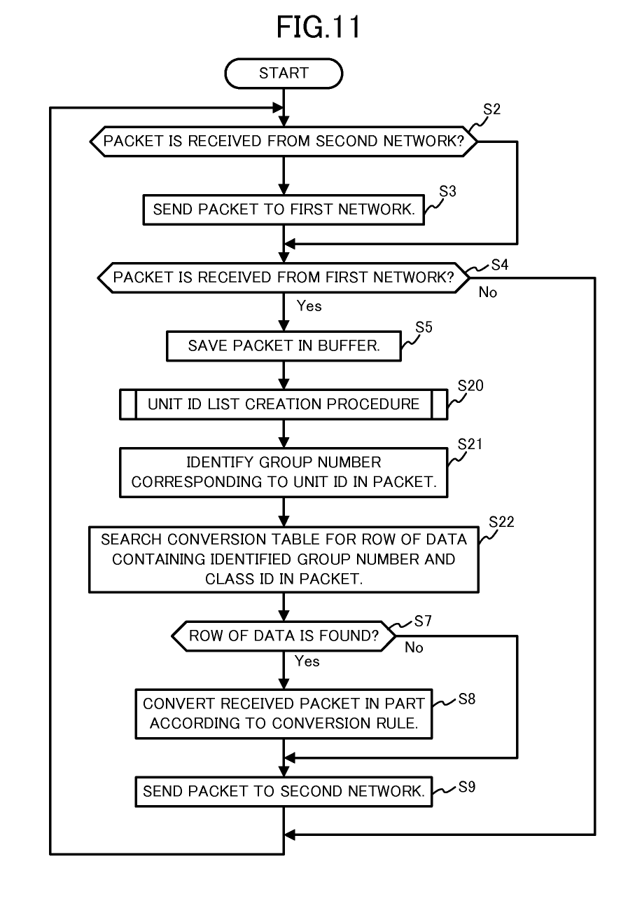

A series of processing executed by the communication relay device 10 will be described hereafter using FIGS. 11 to 13.

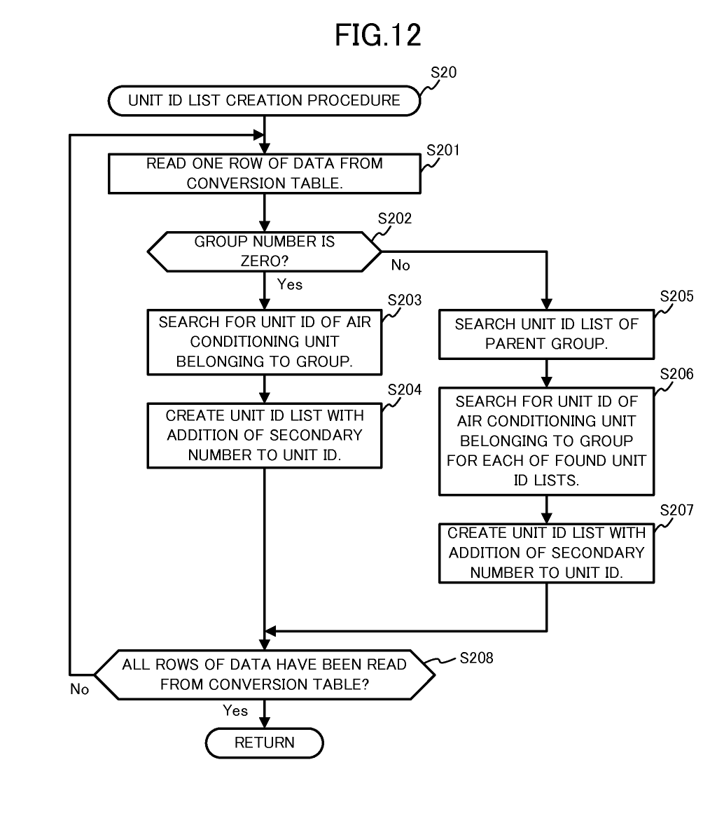

As shown in FIG. 11, following the Steps S2 to S5, the processor 11 executes the unit ID list creation procedure (Step S20). In the unit ID list creation procedure, as shown in FIG. 12, the processor 11 first reads one row of data in the conversion table 106 at a time (Step S201).

Then, the processor 11 determines whether the group number 109a contained in the row of data is zero (Step S202).

If the group number 109a is zero (Step S202; Yes), the processor 11 searches for the unit IDs of the air conditioning units belonging to this group (Step S203). More specifically, the processor 11 extracts the unit ID of the air conditioning unit of which the unit type 109d is “INDOOR UNIT” from the packets saved in the buffer 103. Then, as a result of the search, the processor 11 finds the unit IDs “21” and “26” of the outdoor units 21 and 26 that have communicated via the communication relay device 10.

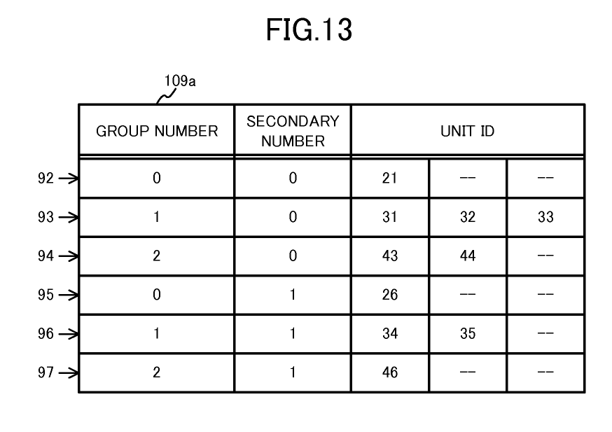

Then, the processor 11 creates a unit ID list for each unit ID with the addition of a secondary number to the unit ID (Step S204). More specifically, the processor 11 adds different secondary numbers to multiple unit IDs and creates a unit ID list corresponding to the same group number 109a for each unit ID. For example, when the unit IDs “21” and “26” are found, the processor 11 creates lists 92 and 95 shown in FIG. 13. Here, the secondary number means a number additionally given to a unit ID.

Subsequently, the processor 11 advances the processing to Step S208.

On the other hand, if the group number 109a is not zero in the Step S202 (Step S202; No), the processor 11 searches for the unit ID list 108 of the parent group (Step S205). More specifically, the processor 11 searches for the unit ID list 108 containing the parent group number 109b indicating the parent group as the group number 109a.

For example, when the group number 109a is 1, the parent group number 109b is zero and therefore the processor 11 finds the lists 92 and 95 of which the group number 109a is zero.

Then, the processor 11 searches for the unit IDs of the air conditioning units belonging to the group based on the packets saved in the buffer 103 for each of the found unit ID lists 108 (Step S206).

For example, the processor 11 searches the packets saved in the buffer 103 for the unit IDs of the indoor units having the “SAME FAMILY” relation to the outdoor unit 21 in regard to the list 92 found in the Step S205. As a result, the processor 11 finds the unit IDs “31,” “32,” and “33” presenting the indoor units 31, 32, and 33.

Furthermore, the processor 11 similarly searches for the unit IDs in regard to the list 95 found in the Step S205. As a result, the processor 11 finds the units IDs “36” and “37” presenting the indoor units 36 and 37.

Then, the processor 11 creates unit ID lists by adding secondary numbers to the unit IDs (Step S207). More specifically, the processor 11 adds the same secondary number as the parent group's to the unit ID to create a unit ID list containing the group number 109a for each secondary number. For example, the processor 11 creates the lists 93 and 95 shown in FIG. 13.

However, if the processor 11 finds the same unit ID duplicated as a result of the search in the Step S206, the processor 11 deletes the duplicated unit ID and creates a unit ID list. For example, when the group number 109a is 2 in the Step S202, the processor 11 finds the unit IDs “43,” “43,” and “44” as the unit IDs of the air conditioning units having the “SAME INTERLINKED” relation to the indoor units 31, 32, and 33, respectively. However, the processor 11 deletes the duplicated unit ID and creates the list 94 shown in FIG. 13.

Then, the processor 11 determines whether all rows of data have been read from the conversion table 106 (Step S208). If not all rows of data have been read (Step S208; No), the processor 11 repeats the processing of the Step S201 and subsequent steps. As a result, the lists 92 to 97 shown in FIG. 13 are created for all groups defined in the conversion table 106.

On the other hand, if all rows of data have been read (Step S208; Yes), the processor 11 ends the unit ID list creation procedure and returns to the series of processing.

Returning to FIG. 12, following the unit ID list creation procedure (Step S20), the processor 11 identifies the group number 109a corresponding to the unit ID in the packet (Step S21). More specifically, the processor 11 identifies the corresponding group number 109a in the unit ID list 108 to the transmission source unit ID contained in the received packet

Then, the processor 11 searches the conversion table 106 for a row of data containing the identified group number 109a and the class ID in the packet (Step S22). For example, when the received packet 76 in FIG. 3 is received, the processor 11 identifies the group number 109a of “1” from the unit ID “33” contained in the received packet 76. Then, the processor 11 searches the conversion table 106 for a row of data containing both this group number 109a and the class ID “SUCTION TEMPERATURE” contained in the received packet 76.

Subsequently, the processor 11 executes the processing of the Steps S7 to S9.

As described above, the conversion table 106 according to this embodiment is static data defining the relation between the groups. Using the conversion table 106, the communication relay device 10 dynamically creates a unit ID list 108 presenting the configuration of the air conditioning equipment 20. Then, the communication relay device 10 converts signals based on the unit ID list 108. As a result, the user can predefine conversion rules suitable for various configurations of the air conditioning equipment 20. Thus, it is possible to reduce intricate works for setting conversion rules for the operation test and prevent erroneous inputs.

Embodiments of the present disclosure are described above. The present disclosure is not confined to the above-described embodiments.

In the above-described embodiments, the communication relay device 10 and control device 41 are independent devices. However, this is not restrictive. For example, it is possible to execute the processing of these devices using the same CPU and use a shared RAM for data exchange. In such a configuration, the processing of the communication relay device 10 and the processing of the control device 41 can easily be consolidated because the capacity of the RAM used by the communication relay device 10 is small.

Furthermore, the communication relay device 10 is connected between the control device 41 and air conditioning equipment 20. This is not restrictive. For example, the operation test target device is not restricted to the control device and can be any device as long as the device is connected to the air conditioning equipment 20 via the communication relay device 10.

The functions of the communication relay device 10 according to the above-described embodiments can be realized by dedicated hardware or a conventional computer system.

For example, the programs 18 stored in the auxiliary storage 13 can be saved and distributed on a computer-readable non-transitory recording medium such as a flexible disk, CD-ROM (compact disk read-only memory), DVD (digital versatile disk), and MO (magneto-optical disk) and installed on a computer to configure a device executing the above-described processing.

Furthermore, the programs 18 can be saved in a disk device of a given server unit on a communication network such as the Internet and, for example, superimposed on carrier waves and downloaded on a computer.

Furthermore, it is possible to activate and execute the programs 18 while transferring the same via a network such as the Internet so as to achieve the above-described processing.

It is further possible that with the programs 18 being executed in whole or in part on a server unit, a computer executes the programs 18 while transmitting/receiving information regarding the processing via a network so as to achieve the above-described processing.

When the above-described functions are realized in part by an OS (operating system) or realized by cooperation of an OS and application programs, only the non-OS part can be stored and distributed on a medium or downloaded on a computer.

Furthermore, the means for realizing the functions of the communication relay device 10 is not restricted to software and some or all of the functions can be realized by dedicated hardware (circuits or the like).

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### INDUSTRIAL APPLICABILITY

The communication relay device, communication relay method, and program of the present disclosure are suitable for operation tests when control devices are installed.

### REFERENCE SIGNS LIST

100 Air conditioning system
10 Communication relay device
11 Processor
12 Main storage
13 Auxiliary storage
14 Inputter
15 Outputter
16 Communication interface
161 Reception unit
162 Transmission unit
17 Internal bus
18 Programs
101 Control signal relay
102 Unit signal relay
103 Buffer
104, 106 Conversion table
105 User interface
107 Unit ID list creation unit
108 Unit ID list
109 Group definition section
109a Group number
109b Parent group number
109c Group relation
109d Unit type
20 Air conditioning equipment
21, 26 Outdoor unit
21a, 31a, 32a, 33a Sensor
31, 32, 33, 36, 37 Indoor unit
41, 42 Control device
43, 44, 46 Operation terminal
61 First network
62 Second network
71 to 78 Received packet
80 Display screen
81 Configuration area
82 Setting area
83 Setting table
83a Received class ID
83b Received data value
83c Setting box
84 Box
91 Row of data
92 to 97 List

1. A communication relay device, comprising:
a receiver configured to receive signals sent from air conditioning units provided with sensors and containing output values of the sensors;
a converter configured to convert the signals received by the receiver to signals containing values that are used for testing an operation of a control device for controlling the air conditioning units and that are different from the output values; and
a transmitter configured to transmit the signals converted by the converter to the control device.

2. The communication relay device according to claim 1, further comprising:
a relay configured to receive the signals sent from the control device and transmit the received signals to the air conditioning units.

3. The communication relay device according to claim 1, further comprising:
a storage configured to store rules for converting the signals,
wherein the converter is configured to convert the signals by rewriting the output values contained in the signals received by the receiver according to the rules stored by the storage.

4. The communication relay device according to claim 3, wherein
the storage is configured to associate and store unit information for identifying the air conditioning units and the rules, and
the converter is configured to convert a signal according to a rule, of the rules, associated with the unit information presenting an air conditioning unit, of the air conditioning units, having transmitted the signal.

5. The communication relay device according to claim 4, further comprising:
a display configured to display, to a user, the unit information presenting the air conditioning unit having transmitted the signal received by the receiver and an output value, of the output values, contained in the signal received by the receiver; and
input means for acquiring an inputter configured to acquire the unit information and the rules entered by the user.
wherein the storage is configured to mutually associate and store the unit information and the rules acquired by the inputter.

6. The communication relay device according to claim 3, wherein
the storage is configured to associate and store group information for identifying groups the air conditioning units belong to and the rules, and
the converter is configured to create a unit information list for identifying the air conditioning units belonging to a group for each group presented by the group information stored in the storage, identify the group information presenting the group to which an air conditioning unit, of the air conditioning units, having transmitted a signal belongs using the created list, and convert the signal according to the rule associated with the identified group information.

7. The communication relay device according to claim 6, wherein
the group information stored in the storage is information for identifying a group to which an air conditioning unit belongs based on a relation to another group.

8. The communication relay device according to claim 3, wherein
the storage is configured to associate and store class information for identifying a class to which an output value of the output values belongs and the rules, and
the converter is configured to identify the class information of the class to which the output value contained in a signal belongs and rewrite the output value according to the rule associated with the identified class information.

9. A communication relay method, comprising:
receiving signals sent from air conditioning units provided with sensors and containing output values of the sensors;
converting the received signals to signals containing values that are used for testing an operation of a control device for controlling the air conditioning units and that are different from the output values; and
transmitting the converted signals to the control device.

10. A non-transitory computer-readable recording medium storing a program for allowing a computer to perform steps comprising:
receiving signals sent from air conditioning units provided with sensors and containing output values of the sensors;
converting the received signals to signals containing values that are used for testing an operation of a control device for controlling the air conditioning units and that are different from the output values; and
transmitting the signals converted by the converter to the control device.
